(19) United States
(12) Patent Application Publication
(10) Pub. No.: US 2011/0056817 A1
(43) Pub. Date: Mar. 10, 2011

(54) KEY MODULE AND MANUFACTURING METHOD FOR KEYCAP THEREOF

(75) Inventor: KUO-HSIANG WU, Tu-Cheng (TW)

(73) Assignee: HON HAI PRECISION INDUSTRY CO., LTD., Tu-Cheng (TW)

(21) Appl. No.: 12/752,162

(22) Filed: Apr. 1, 2010

(30) Foreign Application Priority Data
Sep. 7, 2009 (CN) 200910306634.9

(51) Int. Cl. H01H 13/76; H01H 11/00

(52) U.S. Cl. 200/344; 29/622

(57) ABSTRACT

A key module includes a circuit board including a first conductive portion, a spacer sheet, a membrane circuit board, an elastic assembly, and a keycap. The spacer sheet is fixed on the circuit board, and defines a through hole. The membrane circuit board is fixed on the spacer sheet, and includes a second conductive portion. The elastic assembly is fixed on the membrane circuit board. The keycap is resiliently supported by the elastic assembly, and includes a body and an oxide film attached on the body. The body is made of a first type of metal. The oxide film is made of a second type of metal and for protecting the body. When the keycap is pressed, the elastic assembly deforms, the second conductive portion passes through the through hole to electrically connect with the first conductive portion, so as to form a closed circuit.

### BACKGROUND

1. Technical Field

The present disclosure relates to key modules, and particularly to a key module with reduced height.

2. Description of Related Art

Generally, keyboards utilized in electronic devices, such as desktop computers, notebook computers and mobile phones, tend to be ultra-thin and elegant. However, keycaps of the keyboard, typically have a certain size and height and are made of plastic, therefore the thickness of the keyboard cannot be decreased any further.

Therefore, what is needed is to provide a key module, which can address the problem described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the two views.

FIG. 1 is a cross-sectional view of a key module in accordance with an exemplary embodiment.

FIG. 2 is a flowchart of a manufacturing method for a keycap of a key module in accordance with an exemplary embodiment.

### DETAILED DESCRIPTION

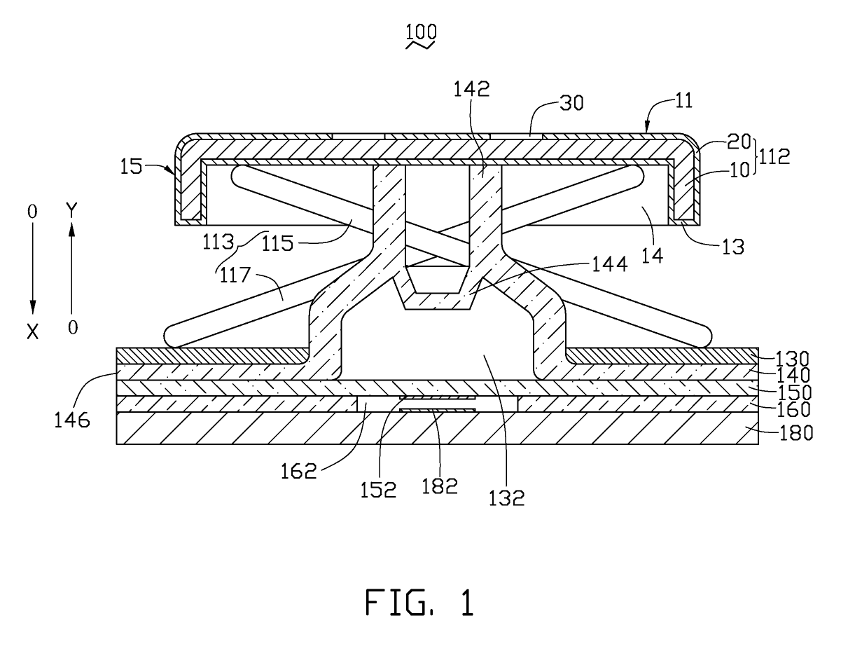

Referring to FIG. 1, a key module 100 according to an exemplary embodiment is illustrated. The key module 100 may be used as an input device in an electronic device (not shown), such as a portable computer, a mobile phone, and a personal digital assistant (PDA). The key module 100 is operable for inputting commands and/or information to the electronic device.

The key module 100 includes a keycap 112, a scissor-type connection mechanism 113, a fixing plate 130, an elastic assembly 140, a membrane circuit board 150, a spacer sheet 160, and a circuit board 180 for mounting the above-mentioned components thereon.

The keycap 112 is resiliently supported on the circuit board 180 by the elastic assembly 140. The keycap 112 includes a body 10 and an oxide film 20. The oxide film 20 is attached on the body 10, and configured for protecting the body 10.

The keycap 112 is made of a first type of metal. The oxide film 20 is made of a second type of metal. In this embodiment, the first type of metal is the same as the second type of metal. In other embodiments, the first type of metal can be different from the second type of metal. As the same type of metal, the combination between the oxide film 20 and the body 10 is enhanced.

Comparing with a traditional keycap made of plastic, the keycap 112 is thinner. In this embodiment, the first type of metal is aluminum alloy. In other embodiments, the first type of metal can be aluminum, or other metal, or other metal alloy. Because the keycap 112 is made of metal, the keycap 112 has a pleasant appearance and is resilient and comfortable.

The oxide film 20 is formed by anodizing. So the surface of the oxide film 20 includes a plurality of holes, the holes are for the surface to adsorb dyes and coloring matter. The ability for decorating the keycap 112 is improved. In addition, the oxide film 20 has a compact structure, and does not tarnish or rust easily. In other embodiments, the oxide film 20 can be further processed by hot water, or high-temperature water vapor, or nickel salts, the processed oxide film 20 will have good abrasion and corrosion resistance.

The keycap 112 includes a first surface 11, a second surface 13 opposite to the first surface 11, and a sealed side surface 15 is connected between the first surface 11 and the second surface 13. The first surface 11 is capable of receiving an external force from pressing. The first surface 11 includes a decoration 30, such as a letter “D”. The decoration 30 is etched into the first surface 11 by laser. Compared with a traditional decoration formed on the plastic keycap by printing, the decoration 30 in the metal keycap 112 has better abrasion resistance. The second surface 13 is for transmitting the external force from the first surface 11. A recess 14 is defined in the second surface 13.

The scissor-type connection mechanism 113 includes a first support leg 115 and a second support leg 117 intersecting with each other. Each support leg 115 and 117 has a first end pivotably connected to the fixing plate 130, and a second end slidably received in the recess 14 and connected to the keycap 112.

The circuit board 180 has one surface including at least a first conductive portion 182. The first conductive portion 182 may be a contact or a trace. In this embodiment, the circuit board 180 is a printed circuit board (PCB).

The membrane circuit board 150 is made of elastic material, such as mylar. The membrane circuit board 150 deforms when an external force is applied to it. The membrane circuit board 150 has one surface including at least a second conductive portion 152 aligned with (facing towards) the first conductive portion 182. The second conductive portion 152 may also be a contact or a trace.

The spacer sheet 160 is disposed between the circuit board 180 and the membrane circuit board 150. The spacer sheet 160 defines at least a first through hole 162 for allowing the first conductive portion 182 to contact the second conductive portion 152. When the key module 100 is in a free (normal) state, the second conductive portion 152 and the first conductive portion 182 are separated by the thickness of the spacer sheet 160, thus, forming an open circuit.

The elastic assembly 140 is disposed on a surface of the membrane circuit board 150 opposite to the surface having the second conductive portion 152. The elastic assembly 140 includes a first part formed as a substantially flat plate 146, and a second part (not labeled) protruding from the substantially flat plate 146. The second part integrally includes a resilient member 142 and an actuating member 144.

The resilient member 142 is made of non-transparent material, and has an end thereof connected to the keycap 112. When the keycap 112 is pressed by an external force, the resilient member 142 deforms, and moves along a first direction (see O-X of FIG. 1) substantially perpendicularly to and towards the circuit board 180. After the external force is released, the resilient member 142 can provide a restoring force for pushing the keycap 112 along a second direction (see O-Y of FIG. 1) opposite to the first direction, to return the keycap 112 to the normal state.

When the resilient member 142 deforms, the actuating member 144 can press the membrane circuit board 150, through the first through hole 162, so the second conductive portion 152 can contact the first conductive portion 182, thus, forming a closed circuit.

The fixing board 130 is disposed above and parallel to the flat plate 146. The fixing board 130 is configured for fixing the elastic assembly 140 and connecting the scissor-type connection mechanism 113. The fixing board 130 defines at least a second through hole 132. The second through hole 132 is arranged for allowing the resilient member 142 to be displaced (move) towards the membrane circuit board 150 along the first direction. In this embodiment, the fixing board 130 is made of metal to enhance the structural strength of the key module 100.

When assembling, first, the key module 100 is assembled by sequentially mounting the spacer sheet 160, the membrane circuit board 150, the elastic assembly 140, and the fixing plate 130 on the circuit board 180. The fixing plate 130 is disposed substantially parallel to, and above, the flat plate 146. The resilient member 142 extends through the second through hole 132 defined by the fixing plate 130. Second, the resilient member 142 is connected to the keycap 112, and the scissor-type connection mechanism 113 is coupled between the keycap 112 and the fixing plate 130.

When the keycap 112 is pressed, the resilient member 142 becomes deformed, and displaces the actuating member 144 toward the resilient member 142, thus, pressing the membrane circuit board 150. As a result, the membrane circuit board 150 becomes deformed, causing the second conductive portion 152 to electrically contact the first conductive portion 182, thereby forming a closed circuit and generating a signal indicating that the key module 100 is being pressed.

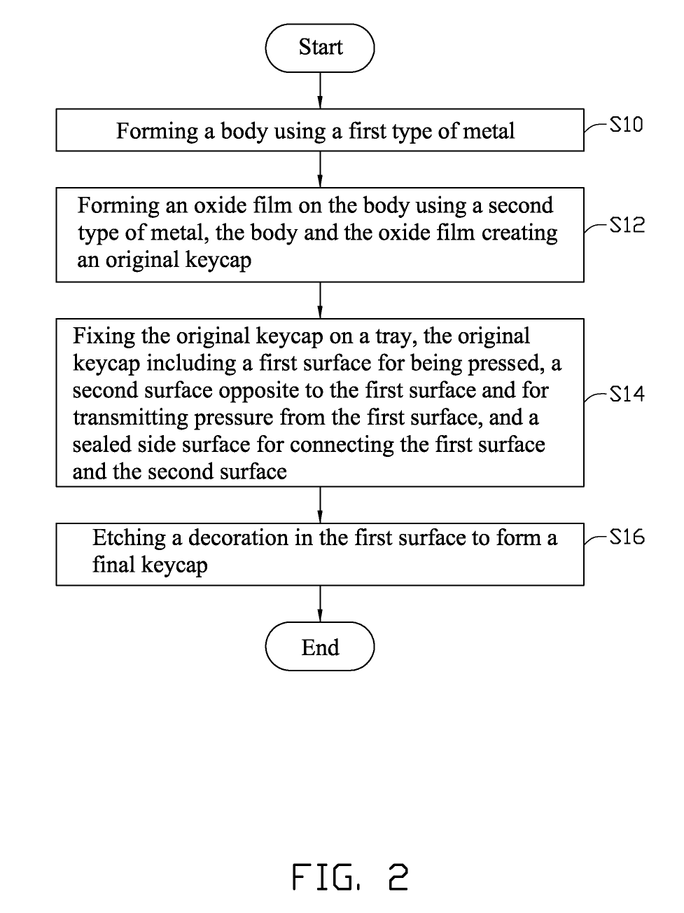

Referring to FIG. 2, a flowchart of a manufacturing method for the keycap 112 of the key module 100 in accordance with an exemplary embodiment is shown. The manufacturing method shown includes the following steps.

In step S10, forming a body using a first type of metal.

In step S12, forming an oxide film on the body using a second type of metal, the body and the oxide film creating an original keycap. In this embodiment, the first and the second types of metal are aluminum alloys. In other embodiments, the first and the second types of metal can be other metallic alloys or other metal, and the first type of metal can be different from the second type of metal. The oxide film is formed by anodizing.

In step S14, fixing the original keycap on a tray, the original keycap including a first surface for being pressed, a second surface opposite to the first surface and for transmitting pressure from the first surface, and a sealed side surface for connecting the first surface and the second surface.

In step S16, etching a decoration in the first surface to form a final keycap. In this embodiment, the decoration is etched in the first surface by laser.

The final keycap formed by the manufacturing method has the same advantages as the keycap 112 of the key module 100.

It is to be understood, however, that even though numerous embodiments have been described with reference to particular embodiments, but the present disclosure is not limited to the particular embodiments described and exemplified, and the embodiments are capable of considerable variation and modification without departure from the scope of the appended claims.

What is claimed is:

1. A key module, comprising:
a circuit board comprising a first conductive portion;
a spacer sheet fixed on the circuit board, and defining a through hole;
a membrane circuit board fixed on the spacer sheet, and comprising a second conductive portion facing to the first conductive portion through the through hole;
an elastic assembly fixed on the membrane circuit board; and
a keycap resiliently supported by the elastic assembly, the keycap comprising a body and an oxide film attached on the body, the body made of a first type of metal, the oxide film made of a second type of metal and for protecting the body, when the keycap is pressed, the elastic assembly deforms, the second conductive portion passes through the through hole to electrically connect with the first conductive portion, so as to form a closed circuit.

2. The key module of claim 1, wherein the first type of metal is a same with the second type of metal.

3. The key module of claim 2, wherein the first type of metal and the second type of metal are aluminum.

4. The key module of claim 2, wherein the first type of metal and the second type of metal are aluminum alloys.

5. The key module of claim 1, wherein the first type of metal is different from the second type of metal.

6. The key module of claim 1, wherein the oxide film is formed by anodizing.

7. The key module of claim 1, wherein the keycap comprises a first surface for being pressed, a second surface opposite to the second surface and for transmitting pressure from the first surface, and a sealed side surface for connecting the first surface and the second surface.

8. The key module of claim 7, wherein a decoration is etched in the first surface.

9. The key module of claim 8, wherein the decoration is etched in the first surface by laser.

10. A manufacturing method for a keycap of a key module, comprising:
forming a body of the keycap using a first type of metal; and
forming an oxide film on the body using a second type of metal, the body and the oxide film creating an original keycap.

11. The manufacturing method of claim 10, further comprising:
fixing the original keycap on a tray, the original keycap comprising a first surface for being pressed, a second surface opposite to the first surface and for transmitting pressure from the first surface, and a sealed side surface for connecting the first surface and the second surface; and
etching a decoration in the first surface to form a final keycap.

12. The manufacturing method of claim 10, wherein the first type of metal is a same with the second type of metal.

13. The manufacturing method of claim 12, wherein the first type of metal and the second type of metal are aluminum.

14. The manufacturing method of claim 12, wherein the first type of metal and the second type of metal are aluminum alloys.

15. The manufacturing method of claim 10, wherein the first type of metal is different from the second type of metal.

16. The manufacturing method of claim 11, wherein the decoration is etched in the first surface by laser.

17. The manufacturing method of claim 10, wherein the oxide film is formed by anodizing.
